(19) United States
(12) Patent Application Publication
(10) Pub. No.: US 2025/0076901 A1
(43) Pub. Date: Mar. 6, 2025

(54) INFORMATION PROCESSING DEVICE, UNMANNED AERIAL VEHICLE, AND METHOD FOR DETECTING AIRFRAME ORIENTATION

(71) Applicant: Asaki MATSUMOTO

(72) Inventor: Asaki MATSUMOTO

(21) Appl. No.: 18/564,234

(22) PCT Filed: Dec. 20, 2022
(86) PCT No.: PCT/JP2022/046892

§ 371 Date: Nov. 27, 2023

(51) Int. Cl. G05D 1/86; B64U 10/13; B64U 101/30; G05D 109/20; G06T 7/73

(52) U.S. Cl. CPC G05D 1/86; B64U 10/13; G06T 7/73; B64U 2101/30; G05D 2109/20

(57) ABSTRACT

The management server 3 acquires the image information indicating the image that includes at least a part of the sign attached in advance in the port P where the UAV 1 is placed and is captured by the camera of the UAV 1, and detects the airframe orientation of the UAV 1 on the basis of at least one of the position of the sign and the indication of the sign in the image indicated by the image information.

### TECHNICAL FIELD

One or more embodiments of the present invention relates to a technical field such as a method for efficiently performing a pre-flight inspection of an unmanned aerial vehicle.

### BACKGROUND ART

Conventionally, at the time of pre-flight (pre-takeoff) inspection of an unmanned aerial vehicle such as a drone, a magnetic sensor of the unmanned aerial vehicle is used to confirm whether an airframe orientation of the unmanned aerial vehicle is correct. In the technique of Patent Literature 1, a drone is configured to check whether the magnitude of a magnetic sensor vector is within a predetermined value. Here, Patent Literature 1 discloses that when the magnitude of the magnetic sensor vector exceeds the predetermined value, there is a possibility that the magnetic sensor is abnormal, the range setting of the magnetic sensor is abnormal, or the drone is placed in a strong magnetic environment not suitable for flight.

### CITATION LIST

### Patent Literature

Patent Literature 1: JP 2022-2961 A

### SUMMARY OF INVENTION

### Technical Problem

Meanwhile, in a case where it is determined whether or not the airframe orientation of the unmanned aerial vehicle is correct (that is, whether or not the unmanned aerial vehicle is placed in the correct orientation) on the basis of the direction detected by the magnetic sensor, if the geomagnetism is disturbed, the direction detected by the magnetic sensor may be different from the actual direction. In this case, there is a problem that the airframe orientation of the unmanned aerial vehicle cannot be appropriately detected.

Therefore, one or more embodiments of the present invention are directed to providing an information processing device, an unmanned aerial vehicle, and an airframe orientation detection method capable of appropriately detecting an airframe orientation of the unmanned aerial vehicle even in a case where geomagnetism is disturbed.

### Solution to Issue

(An aspect 1) In response to the above issue, an information processing according to the present aspect includes: a first acquisition unit configured to acquire image information that indicates an image including at least a part of a sign attached in advance in a port in which an unmanned aerial vehicle is placed, the image being captured by a camera in the unmanned aerial vehicle; and a detection unit configured to detect an airframe orientation of the unmanned aerial vehicle on the basis of at least one of a position of the sign and indication of the sign in the image indicated by the image information.

(An aspect 2) An unmanned aerial vehicle according to the present aspect includes: a camera; a first acquisition unit configured to acquire image information that indicates an image including at least a part of a sign attached in advance in a port in which an unmanned aerial vehicle is placed, the image being captured by the camera; and a detection unit configured to detect an airframe orientation of the unmanned aerial vehicle on the basis of at least one of a position of the sign and indication of the sign in the image indicated by the image information.

(An aspect 3) A method executed by a computer for detecting airframe orientation according to the present aspect includes: a step of acquiring, by the computer, image information that indicates an image including at least a part of a sign attached in advance in a port in which an unmanned aerial vehicle is placed, the image being captured by a camera in the unmanned aerial vehicle; and a step of detecting, by the computer, an airframe orientation of the unmanned aerial vehicle on the basis of at least one of a position of the sign and indication of the sign in the image indicated by the image information.

### Advantageous Effect of the Invention

According to one or more embodiments of the present invention, it is possible to appropriately detect an airframe orientation of the unmanned aerial vehicle even in a case where geomagnetism is disturbed.

### BRIEF DESCRIPTION OF THE DRAWINGS

FIG. 1 is a diagram illustrating a schematic configuration example of an UAV inspection system S.

FIG. 2 is a diagram illustrating Example 1 of a sign attached to a port P.

FIG. 3 is a diagram illustrating Example 2 of a sign attached to a port P.

FIG. 4 is a diagram illustrating Example 3 of a sign attached to a port P.

FIG. 5 is a diagram illustrating a schematic configuration example of an UAV 1.

FIG. 6 is a diagram illustrating an appearance example of an UAV 1 in a state of landed on a port P.

FIG. 7 is a diagram illustrating a schematic configuration example of a worker terminal 2.

FIG. 8 is a diagram illustrating a schematic configuration example of a management server 3.

FIG. 9 is a diagram illustrating an example of functional blocks in a control unit 33.

FIG. 10 is a diagram illustrating an image I1 of a sign SI1 captured by a camera of an UAV 1.

FIG. 11 is a diagram illustrating an image 12 of a sign SI2 captured by the camera of an UAV 1.

FIG. 12 is a diagram illustrating an image 13 of a sign SI3 captured by a camera of an UAV 1.

FIG. 13 is a diagram illustrating (a) case with no positional deviation of an UAV 1 and (b) case with positional deviation of an UAV 1 in an image I1 indicated by image information.

FIG. 14 is a sequence diagram illustrating an example of processing executed by a worker terminal 2 and a management server 3.

FIG. 15 is a sequence diagram illustrating an example of processing executed by an UAV 1 and a management server 3.

FIG. 16 is a flowchart illustrating details of an inspection process in step S21 illustrated in FIG. 15.

FIG. 17 is a diagram illustrating a display example of an inspection result check screen on a worker terminal 2.

### DESCRIPTION OF EMBODIMENTS

Hereinafter, an embodiment of the present invention will be described with reference to the drawings. Incidentally, the following embodiment is an embodiment in a case where the present invention is applied to a system (hereinafter, referred to as “UAV inspection system”) for performing a pre-flight (pre-takeoff) inspection of an unmanned aerial vehicle (hereinafter, referred to as an “UAV (Unmanned Aerial Vehicle)”) placed (arranged, in other words) at a port. Here, the port is an area (a section, in other words) provided so that the UAV can take off and land, and is also referred to as a takeoff and landing facility. The port is provided, for example, on a ground, an upper surface of a frame, a rooftop surface of a building, or the like in a base (location) where a worker (an example of a staff) belongs. Such a base may be, for example, at a warehouse, a commercial facility, a public facility, or a residential site. One or more ports are provided in one base. For example, the worker performs at least one of work of placing the UAV in the port and work of inspecting the UAV.

[1. Configuration and Operation outline of UAV Inspection System S]

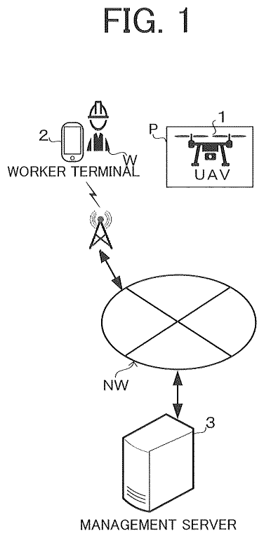

First, with reference to FIG. 1, a configuration and an operation outline of a UAV inspection system S according to the present embodiment will be described. FIG. 1 is a diagram illustrating a schematic configuration example of the UAV inspection system S. As illustrated in FIG. 1, the UAV inspection system S includes a UAV 1, a worker terminal 2, a management server 3, and the like. Incidentally, in the example of FIG. 1, one UAV 1 and one worker terminal 2 are illustrated, but actually, there are a plurality of UAVs 1 and a plurality of worker terminals 2. The UAV 1, the worker terminal 2, and the management server 3 are each connected to a communication network NW. The communication network NW includes, for example, the Internet, a mobile communication network and wireless base stations thereof, or the like.

The UAV 1 is inspected, for example, after being placed in the port P before flight. The inspection is performed by, for example, a worker W, the UAV 1 itself, and the management server 3. For example, the worker W visually inspects a predetermined part of the UAV 1 or inspects by touching the predetermined part of the UAV 1. Inspection by the UAV 1 itself can also be referred to as self-diagnosis. If no abnormality is found in the inspection, the UAV 1 takes off from the port P and flies from the ground toward a destination according to the remote control by an operator or autonomously flies. Incidentally, the UAV 1 is managed by a GCS (Ground Control Station) connected to the communication network NW. For example, the GCS may be mounted as an application on a control terminal, or may be configured by one or more servers or the like.

The worker terminal 2 is a terminal used by the worker W who inspects the UAV 1 in the port P. The worker terminal 2 can receive and display an input of a result of the inspection (inspection result) performed by the worker W, and further transmit inspection result information indicating the inspection result to the management server 3. Moreover, the worker terminal 2 can receive inspection result information indicating the result of the inspection (self-diagnosis) performed by the UAV 1 itself from the management server 3 and display the inspection result information. Further, the worker terminal 2 can receive inspection result information indicating the result of the inspection performed by the management server 3 from the management server 3 and display the inspection result information. As a result, the worker W can check the inspection result on the worker terminal 2.

The management server 3 includes one or a plurality of server computers for managing information on the port P, information on the UAV 1, and information on the worker W. The inspection performed by the management server 3 includes inspection of an airframe orientation of the UAV 1 placed in the port P. Here, the airframe orientation means, for example, a direction (azimuth) in which the front of the UAV 1 faces. Examples of the airframe orientation include facing east, facing west, facing south, facing north, facing east-west, facing east-south, and the like. The airframe orientation may be expressed by, for example, an angle based on the north. A front surface of the UAV 1 is a surface facing the traveling direction (that is, the direction to travel during flight) of the UAV 1. For example, a mark (for example, a company logo, a name, a model number, a marker, and the like) indicating its front surface may be attached to the front surface of the UAV 1. Incidentally, the airframe orientation of the UAV 1 corresponds to the traveling direction of the UAV 1. For example, the airframe orientation “facing east” of the UAV 1 corresponds (matches, for example) to the traveling direction “east” of the UAV 1.

A sign for detecting the airframe orientation of the UAV 1 by image analysis (image recognition) is attached (installed, in other words) to the port P in advance. Such a sign is composed of a predetermined character (for example, a character indicating a direction), a number, a symbol, a mark, a color, color-coding, a pattern, or a three-dimensional shape (object), or a combination thereof, which are components of the sign. Examples of the sign attached to the port P include directly drawing a sign on the upper surface of the port P (the surface of soil or concrete, for example), laying a sheet on which a sign is drawn on the upper surface of the port P, and displaying a sign on a display constituting the upper surface of the port P. Alternatively, as another example of the sign attached to the port P, an object (a block, for example) as a sign is arranged on the upper surface of the port P or around the port P.

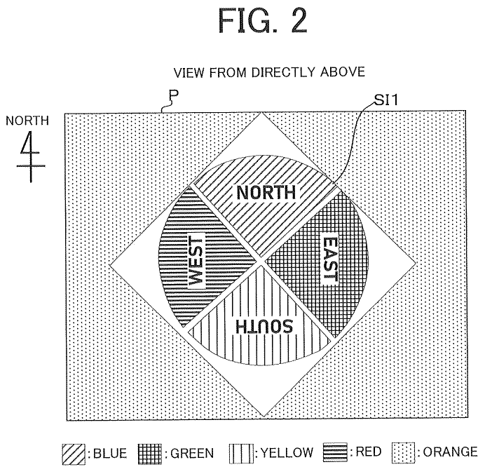

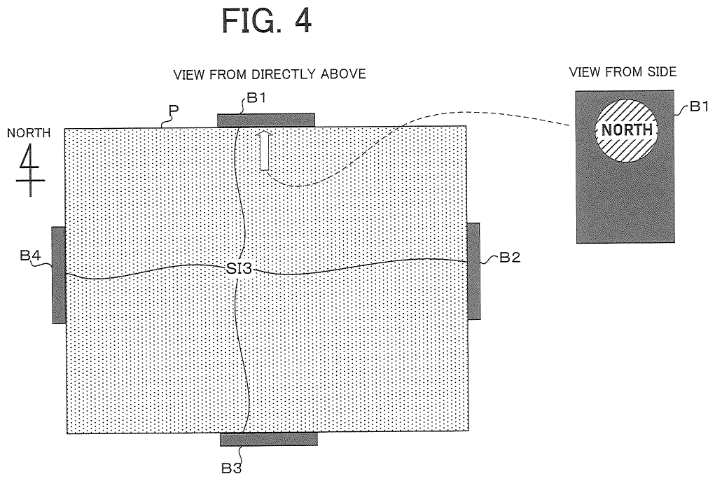

FIGS. 2 to 4 are diagrams illustrating Examples 1 to 3 of the sign attached to the port P. FIGS. 2 to 4 illustrate views of the port P as viewed from directly above, and FIG. 4 further illustrates a view as viewed from the side (the direction indicated by the arrow). The sign SI1 illustrated in FIG. 2 includes characters indicating a direction (NORTH, EAST, SOUTH, WEST) and color coding (blue, green, yellow, red), and is drawn at the center of the upper surface of the port P. The color (referred to as “port color”) of the upper surface (the region other than the sign SI1) of the port P illustrated in FIG. 2 is orange. Incidentally, the sign SI1 may include only characters indicating the directions. Moreover, the sign SI1 may be configured only by color coding, and in this case, a correspondence between a color (for example, green) and a direction (for example, east) is defined in advance.

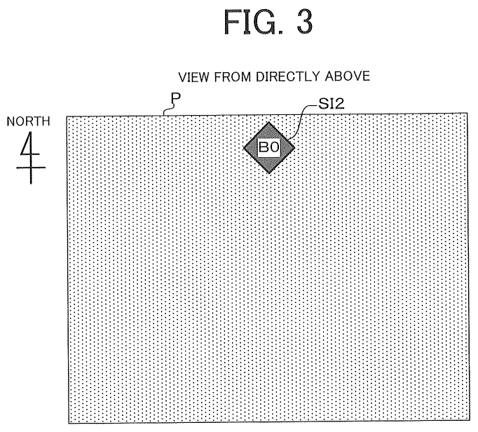

Moreover, the sign SI2 illustrated in FIG. 3 includes an object B0 and is arranged on the north side of the upper surface of the port P. Moreover, the sign SI3 illustrated in FIG. 4 includes four objects B1 to B4, and the objects B1 to B4 are placed on the north side, the east side, the south side, and the west side around the port P, respectively. On a side surface (port P side) of the object B1 arranged on the north side among the objects B1 to B4, a character and a color indicating north are drawn. Incidentally, in the examples of FIGS. 2 to 4, the shape of the port P is a quadrangle, but may be a circle, an ellipse, or another rectangle.

### [1-1. Configuration and Function of UAV 1]

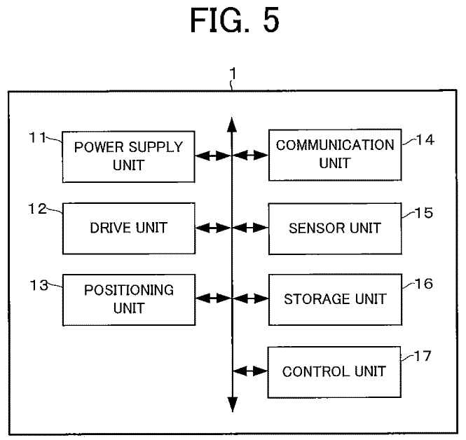

Next, with reference to FIG. 5 the configuration and function of the UAV 1 will be described. FIG. 5 is a diagram illustrating a schematic configuration example of the UAV 1. As illustrated in FIG. 5, the UAV 1 includes a power supply unit 11, a drive unit 12, a positioning unit 13, a communication unit 14, a sensor unit 15, a storage unit 16, a control unit 17, and the like. Furthermore, the UAV 1 includes a propeller (rotor) that is a horizontal rotary wing, an arm pipe (including an arm joint) for attaching the propeller to the UAV main body (housing), and the like. Incidentally, in a case where the UAV 1 is used for delivery of an article, the UAV 1 includes a holding mechanism or the like for holding the article.

The power supply unit 11 includes a detachable battery (power storage device) and the like. When the power switch is turned on, the power supply unit 11 supplies (provides) the power stored in the battery to each unit of the UAV 1. Moreover, the power supply unit 11 sequentially measures the remaining battery capacity. Battery information indicating the remaining battery capacity measured by the power supply unit 11 is output to the control unit 17. The drive unit 12 includes a motor, a rotation shaft, and the like. The drive unit 12 rotates the plurality of rotors by a motor, a rotation shaft, and the like that are driven in accordance with a control signal output from the control unit 17.

The positioning unit 13 includes a radio wave receiver, an altitude sensor, and the like. The positioning unit 13 receives, for example, a radio wave transmitted from a satellite of a GNSS (Global Navigation Satellite System) such as a GPS (Global Positioning System) by the radio wave receiver, and sequentially detects the current position (latitude and longitude) of the UAV 1 in the horizontal direction on the basis of the radio wave. Position information indicating the current position detected by the positioning unit 13 is output to the control unit 17. Furthermore, the positioning unit 13 may detect the current position (altitude) of the UAV 1 in the vertical direction by the altitude sensor. In this case, the position information includes altitude information indicating the altitude of the UAV 1.

The communication unit 14 has an antenna and a wireless communication function, and controls communication performed via the communication network NW. The sensor unit 15 includes various sensors used for controlling the UAV 1. Examples of the various sensors include a magnetic sensor (compass), a triaxial angular velocity sensor, a triaxial acceleration sensor, an atmospheric pressure sensor, an optical sensor, a range finder (distance meter), and the like. The optical sensor includes one or a plurality of cameras (for example, an RGB camera and an IR (Infrared rays) camera) and the like. Sensing information sensed by the sensor unit 15 is output to the control unit 17.

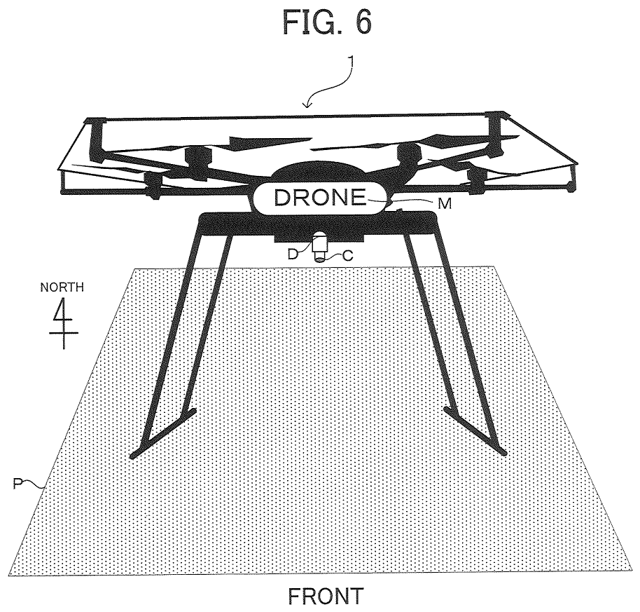

FIG. 6 is a diagram illustrating an appearance example of the UAV 1 in a state of landed on the port P. In the example of FIG. 6, a mark M (for example, the name of the UAV 1, the operator name, a logo, and the like) indicating its front surface is attached to the front surface of the UAV 1, and the front surface of the UAV 1 faces south (That is, the airframe orientation is facing south.). Moreover, a camera C is rotatably attached to a camera driving unit D in a lower portion of the UAV 1. As illustrated in FIG. 6, in a state where the UAV 1 is landed on the port P, the camera C (lens) faces the ground direction (downward direction in the figure) (That is, the direction in which the optical axis of the camera C extends coincides with the ground direction.). With this configuration, the camera C can photograph, for example, the sign SI1 drawn on the upper surface of the port P as illustrated in FIG. 2. Moreover, the camera C can be rotated by the camera driving unit D according to a control command from the control unit 17, for example, so as to face the lateral direction (horizontal direction). With this configuration, the camera C can photograph, for example, the sign SI3 drawn on the side surface of the object B1 arranged on the north side of the port P as illustrated in FIG. 4. Incidentally, the UAV 1 may include a camera facing the ground and a camera facing the traveling direction of the UAV 1.

The storage unit 16 includes a nonvolatile memory or the like, and stores various programs and data. Moreover, the storage unit 16 stores an airframe ID (identification information) for identifying the UAV 1. The control unit 17 includes a CPU (Central Processing Unit), a ROM (Read Only Memory), a RAM (Random Access Memory), and the like, and controls the UAV 1 on the basis of the position information from the positioning unit 13 and the sensing information from the sensor unit 15. Such control includes control of the rotation speed of the propeller, control of the position, attitude, and traveling direction of the UAV 1, and the like.

Moreover, the control unit 17 acquires, from the sensor unit 15, an image that includes at least a part of the sign attached in advance to the port P where the UAV 1 is placed and is captured by the camera of the UAV 1. Image information indicating the image captured by the camera of the UAV 1 and direction information indicating the direction detected by the magnetic sensor of the UAV 1 are transmitted to the GCS via the communication network NW together with the airframe ID of the UAV 1. Then, the image information, the direction information, and the airframe ID of the UAV 1 are transmitted from the GCS to the management server 3. Moreover, the position information (that is, the position information indicating the current position of the UAV 1) of the UAV 1 is transmitted to the GCS via the communication network NW together with the airframe ID of the UAV 1. Then, the position information and the airframe ID of the UAV 1 are transmitted from the GCS to the management server 3. Incidentally, the image information, the position information, and the airframe ID of the UAV 1 may be transmitted from the UAV 1 to the management server 3.

Moreover, the control unit 17 has a self-diagnosis function, and performs an inspection for each inspection item regarding whether or not a predetermined portion (for example, the power supply unit 11, the drive unit 12, the positioning unit 13, the communication unit 14, the sensor unit 15, and the like.) of the UAV 1 normally operates. The inspection items include, for example, the remaining battery capacity, battery cell balance, GPS, magnetic sensor, triaxial angular velocity sensor, triaxial acceleration sensor, atmospheric pressure sensor, optical sensor, range finder, and the like. The inspection result information indicating the inspection result (for example, results for each inspection item) is transmitted to the GCS via the communication network NW together with the airframe ID of the UAV 1 that has performed the inspection. Then, the inspection result information and the airframe ID are transmitted from the GCS to the management server 3. Incidentally, the inspection result information and the airframe ID may be transmitted from the UAV 1 to the management server 3.

### [1-2. Configuration and Function of Worker Terminal 2]

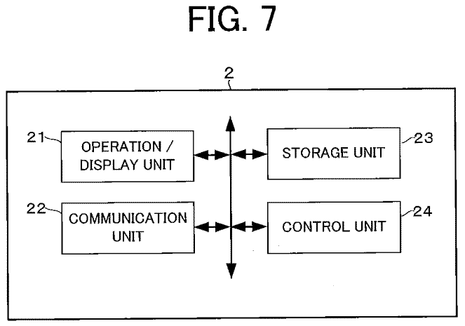

Next, the configuration and function of the worker terminal 2 will be described with reference to FIG. 7. FIG. 7 is a diagram illustrating a schematic configuration example of the worker terminal 2. The worker terminal 2 includes an operation/display unit 21, a communication unit 22, a storage unit 23, a control unit 24, and the like. Incidentally, as the worker terminal 2, for example, a mobile terminal such as a smartphone and a tablet, or a notebook personal computer can be used. The worker terminal 2 may include a voice processing unit and a speaker. The operation/display unit 21 has, for example, an input function of receiving an instruction (an input instruction, a selection instruction, or the like) using a finger, a pen, or the like of the worker W, and a display function of displaying various screens. The communication unit 22 has a wireless communication function and controls communication performed via the communication network NW. The storage unit 23 includes a nonvolatile memory or the like, and stores various programs and data. The various programs include an operating system (OS), a worker application, and a web browser.

The control unit 24 includes a CPU, a ROM, a RAM, and the like, and executes processing according to the worker application stored in the ROM (or the storage unit 23). After the worker application is activated according to the instruction of the worker W, for example, when a user ID and a password are input by the worker W through a login screen, the control unit 24 transmits a login request including the user ID and the password to the management server 3 via the communication unit 22 and the communication network NW. The user ID is identification information for identifying the worker W.

Then, after the worker W logs in upon the login request, when information regarding the UAV 1 to be placed in the port P (for example, the airframe ID, the name, and the status of the UAV 1) is transmitted from the management server 3, the control unit 24 displays the information regarding the UAV 1 on, for example, a UAV information display screen. Moreover, when the inspection result information indicating the inspection result of the UAV 1 is transmitted from the management server 3, the control unit 24 displays the inspection result information on, for example, an inspection result check screen. Moreover, the worker W can input the result of the inspection performed by themselves for each inspection item via the operation/display unit 21. The inspection result information indicating the inspection result (for example, the result for each item) input in this manner and the airframe ID of the inspected UAV 1 are transmitted to the management server 3 together with the user ID via the communication network NW.

### [1-3. Configuration and Function of Management Server 3]

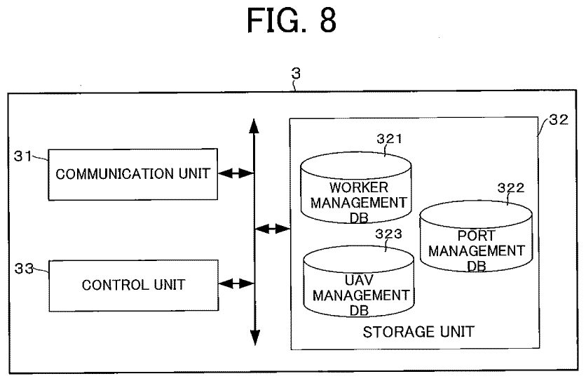

Next, a configuration and a function of the management server 3 will be described with reference to FIG. 8. FIG. 8 is a diagram illustrating a schematic configuration example of the management server 3. As illustrated in FIG. 8, the management server 3 includes a communication unit 31, a storage unit 32, a control unit 33, and the like. The communication unit 31 controls communication performed via the communication network NW. The image information, the direction information, the inspection result information, the position information of the UAV 1, and the airframe ID transmitted from the GCS or the UAV 1 are received by the communication unit 31. The management server 3 can recognize the current position of the UAV 1 from the position information of the UAV 1. The login request transmitted from the worker terminal 2 is received by the communication unit 31. Moreover, the inspection result information, the airframe ID, and the user ID transmitted from the worker terminal 2 after the login of the worker W are received by the communication unit 31.

The storage unit 32 includes, for example, a hard disk drive or the like, and stores an operating system, various programs including applications, and the like. Here, the application includes a program for executing the method for detecting airframe orientation. Further, in the storage unit 32, a worker management database (DB) 321, a port management database (DB) 322, and a UAV management database (DB) 323 are constructed. The worker management database 321 is a database for managing information on the workers W. In the worker management database 321, a user ID and a password of the worker W, a base ID of a base to which the worker W belongs, and the like are stored in association with each worker W. Here, the base ID is identification information for identifying the base.

The port management database 322 is a database for managing information on the ports P. In the port management database 322, for example, a port ID of the port P, a base ID of the base in which the port P is provided, position information of the port P, the port color of the port P, a usage status of the port P, and installation (attachment) information of the sign in the port P are stored in association with each other for each port P. Here, the port ID is identification information for identifying the port P. The position information of the port P indicates, for example, an installation position (for example, the latitude and longitude of the center of the port P) of the port P. The usage status of the port P indicates whether or not the port P is in use (for example, whether a UAV 1 is placed).

The installation information in the sign at the port P indicates what kind of sign is attached and how the sign is attached in the port P. For example, the installation information of the sign at the port P includes information such as components of the sign and the position and orientation of the components in the port P. The information on the sign SI1 illustrated in FIG. 2 includes information indicating that the character “EAST” and the color “green”, which are components of the sign SI1, are drawn on the east side of the port P. Incidentally, the information related to the sign SI1 may include a correspondence between the colors and the directions defined in advance.

Moreover, the information on the sign SI2 illustrated in FIG. 3 includes information indicating that an object that is a component of the sign SI2 is placed on the north side of the port P. Moreover, the information regarding the sign SI3 illustrated in FIG. 4 includes information indicating that an object that is a component of the sign SI3 is placed on the north side near the port P, and the character “NORTH” that is components of the sign SI3 is written on the side surface of the object. Incidentally, the installation information of the sign in the port P may include a photographic image (including a direction) photographed from above the sign in advance.

The UAV management database 323 is a database for managing information related to the UAVs 1. In the UAV management database 323, an airframe ID of the UAV 1, a base ID of a base that manages the UAV 1, the name of the UAV 1, a model number of the UAV 1, position information of the UAV 1, a status (current state) of the UAV 1, inspection result information, and the like are stored in association with each UAV 1. Here, the position information and the status of the UAV 1 are updated as appropriate. Examples of the status of the UAV 1 include waiting to be placed, waiting for inspection, being inspected, inspection completed, flyable, not flyable (having abnormality), in flight, and the like. For example, a scheduled departure time and a scheduled return time are determined for the UAV 1 whose status becomes flyable from being inspected, and registered in the UAV management database 323.

Incidentally, when a flight route of the UAV 1 has been set (determined), the flight route is stored in the UAV management database 323 in association with the airframe ID of the UAV 1. The flight route is represented by, for example, positions of a plurality of via-points on the flight route. The determination timing of the flight route of the UAV 1 may be before the inspection or after the inspection of the UAV 1. The inspection result information includes the latest inspection result for each inspection item. The inspection result information is updated, for example, every time the inspection result information is received by the communication unit 31.

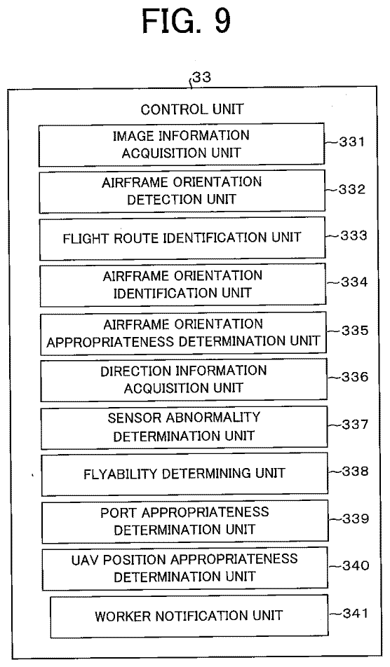

The control unit 33 (an example of a computer) includes at least one CPU, a ROM, a RAM, and the like. FIG. 9 is a diagram illustrating an example of functional blocks in the control unit 33. For example, according to a program (program code group) stored in the ROM or the storage unit 32, as illustrated in FIG. 9, the control unit 33 functions as an image information acquisition unit 331 (an example of a first acquisition unit), an airframe orientation detection unit 332 (an example of a detection unit), a flight route identification unit 333 (an example of a first identification unit), an airframe orientation identification unit 334 (an example of a second identification unit and a third identification unit), an airframe orientation appropriateness determination unit 335 (an example of a second determination unit), a direction information acquisition unit 336 (an example of a second acquisition unit), a sensor abnormality determination unit 337 (an example of a first determination unit), a flyability determining unit 338 (an example of a determining unit), a port appropriateness determination unit 339 (an example of a third determination unit), a UAV position appropriateness determination unit 340 (an example of a fourth determination unit), and a worker notification unit 341 (an example of a notification unit).

The image information acquisition unit 331 acquires, via the communication unit 31, image information indicating an image (an image captured by the camera of the UAV 1) including at least a part of a sign attached in advance to the port P where the UAV 1 is placed. The airframe orientation detection unit 332 detects the airframe orientation of the UAV 1 on the basis of at least one of the position of the sign and the indication of the sign in the image indicated by the image information acquired by the image information acquisition unit 331. When detecting the airframe orientation of the UAV 1, the airframe orientation of the UAV 1 can be more accurately detected by referring to the installation information of the sign in the port P where the UAV 1 is placed.

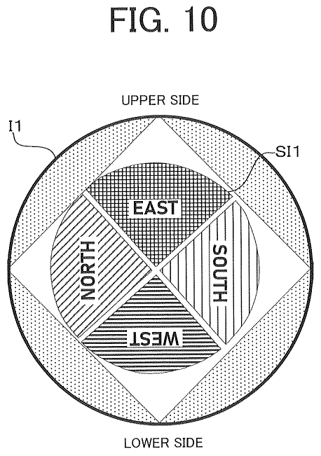

FIG. 10 is a diagram illustrating an image I1 of the sign SI1 illustrated in FIG. 2 captured by the camera of the UAV 1. In the example of FIG. 10, since the character “EAST” and the color “green”, which are components of the sign SI1, appear on the upper side in the image I1, it can be seen that the image I1 was captured in a state where the front of the UAV 1 faces east. In this case, the airframe orientation detection unit 332 performs image analysis on the image I1, and detects the airframe orientation “facing east” of the UAV 1 by recognizing the character “EAST” or the color “green” on the upper side in the image I1. That is, the airframe orientation detection unit 332 can detect the airframe orientation of the UAV 1 on the basis of the position (the upper side in the image I1 in this example) and indication (the character or the color in this example) of the sign SI1 in the image I1. With this configuration, the airframe orientation of the UAV 1 can be more accurately detected. Incidentally, since the character “EAST” is located on the upper side in the image I1, the airframe orientation detection unit 332 can detect that the airframe orientation of the UAV 1 is the east orientation without referring to the installation information of the sign SI1.

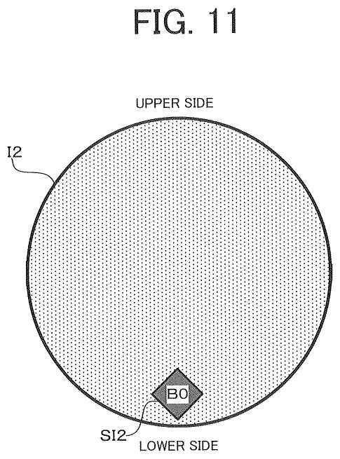

FIG. 11 is a diagram illustrating an image 12 of the sign SI2 illustrated in FIG. 3 captured by the camera of the UAV 1. In the example of FIG. 11, since the object B0, which is a component of the sign SI2, appears on the lower side in the image 12, it can be seen that the image 12 is captured in a state where the front of the UAV 1 faces the south on the basis of the installation information of the sign SI2. In this case, the airframe orientation detection unit 332 performs image analysis of the image 12 and detects the airframe orientation “facing south” of the UAV 1 by recognizing the object B0 appearing on the lower side in the image 12. That is, the airframe orientation detection unit 332 can detect the airframe orientation of the UAV 1 on the basis of the position (the lower side in the image 12 in this example) of the sign SI2 in the image 12.

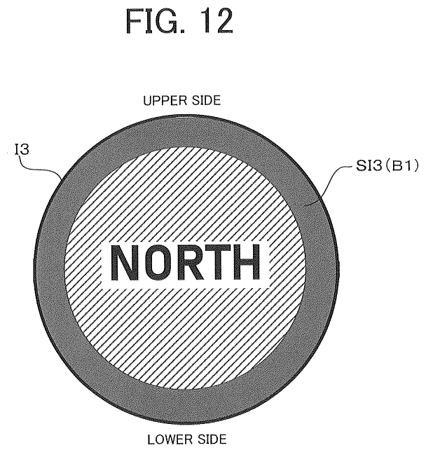

FIG. 12 is a diagram illustrating an image 13 of the sign SI3 illustrated in FIG. 4 captured by the camera of the UAV 1. In the example of FIG. 12, since the character “NORTH” and the color “blue” drawn on the side surface of the object B1, which is a component of the sign SI3, appear in the image 13, it can be seen that the image 13 has been captured in a state where the front of the UAV 1 faces north. In this case, the airframe orientation detection unit 332 performs image analysis of the image 13 and detects the airframe orientation “facing north” of the UAV 1 by recognizing the character “NORTH” or the color “blue” seen in the image 13. That is, the airframe orientation detection unit 332 can detect the airframe orientation of the UAV 1 on the basis of the indication (the word or the color in this example) of the sign SI3 in the image I3.

In a case where the flight route of the UAV 1 placed in the port P has been determined, the planed flight route identification unit 333 identifies the flight route of the UAV 1 from, for example, the UAV management database 323. The airframe orientation identification unit 334 identifies the airframe orientation (that is, the airframe orientation of the UAV 1) according to the flight route identified by the flight route identification unit 333. For example, the airframe orientation identification unit 334 identifies the airframe orientation by calculating the traveling direction (that is, a direction in which UAV 1 is going to fly away) of the UAV 1 from the port P on the basis of the flight route of the UAV 1. Alternatively, first association information that each of associates flight routes with each of airframe orientations (traveling directions) may be referred to. In this case, the airframe orientation identification unit 334 identifies the airframe orientation associated with the flight route that matches the flight route identified by the flight route identification unit 333, based on the first association information.

Alternatively, the airframe orientation identification unit 334 may identify the airframe orientation with respect to the port P where the UAV 1 is placed. For example, the airframe orientation identification unit 334 refers to second association information that associates each of port colors with each of airframe orientations, and identifies the airframe orientation with respect to the port P. In the second association information, for example, the port color “light blue” is associated with the airframe orientation “facing north”, and the port color “orange” is associated with the airframe orientation “facing south”.

The airframe orientation appropriateness determination unit 335 determines whether the airframe orientation of the UAV 1 placed in the port P is appropriate (satisfies a prescribed condition) by comparing the airframe orientation detected by the airframe orientation detection unit 332 with the airframe orientation identified by the airframe orientation identification unit 334. As a result, it is possible to accurately detect that the UAV 1 is placed in an inappropriate airframe orientation. For example, in a case where the difference (angle difference) between the airframe orientation detected by the airframe orientation detection unit 332 and the airframe orientation identified by the airframe orientation identification unit 334 is less than a threshold sh11 (45 degrees for example), it is determined that the airframe orientation of the UAV 1 is appropriate.

The direction information acquisition unit 336 acquires the direction information indicating the direction detected by the magnetic sensor of the UAV 1 via the communication unit 31. The sensor abnormality determination unit 337 determines whether or not the magnetic sensor of the UAV 1 is abnormal by comparing the direction indicated by the airframe orientation detected by the airframe orientation detection unit 332 with the direction indicated by the direction information acquired by the direction information acquisition unit 336. With this configuration, the abnormality of the magnetic sensor of the UAV 1 can be accurately detected. For example, when the difference (angle difference) between the direction indicated by the airframe orientation detected by the airframe orientation detection unit 332 and the direction indicated by the direction information acquired by the direction information acquisition unit 336 is equal to or greater than the threshold sh11 (45 degrees, for example) (that is, when the difference between both directions is large), the sensor abnormality determination unit 337 determines that the magnetic sensor of the UAV 1 is abnormal. As a result, the abnormality of the magnetic sensor of the UAV 1 can be efficiently detected. Incidentally, the threshold sh11 is an example of a first threshold, and a threshold sh12 described later is an example of a second threshold.

When the sensor abnormality determination unit 337 determines that the magnetic sensor of the UAV 1 is abnormal, the flyability determining unit 338 determines (settles) prohibition of takeoff of the UAV 1. With this configuration, the flight of the UAV 1 in which the magnetic sensor is abnormal can be efficiently prevented. The port appropriateness determination unit 339 determines whether or not the port P in which the UAV 1 is placed is appropriate on the basis of the port color identified by the color identification algorithm from the image indicated by the image information acquired by the image information acquisition unit 331 and the port color (that is, the port color associated in the port management database 322) associated with the port ID of the port P in which the UAV 1 is placed. With this configuration, it is possible to accurately detect that the UAV 1 is arranged in an inappropriate port P. For example, when the matching degree (similarity) between the port color identified from the image and the port color associated with the port ID is equal to or greater than the threshold sh12 (90%, for example), it is determined that the port P in which the UAV 1 is placed is appropriate. Incidentally, in identifying the port color from the image, the part of the sign attached in the port P is excluded by referring to the installation information of the sign.

The UAV position appropriateness determination unit 340 determines whether the position (placement position) of the UAV 1 placed in port P is appropriate on the basis of at least one of the position of the sign and the indication of the sign in the image indicated by the image information acquired by the image information acquisition unit 331. In other words, it is determined whether or not there is positional deviation of the UAV 1 placed in the port P. With this configuration, it is possible to accurately detect that the UAV 1 is arranged at an inappropriate position.

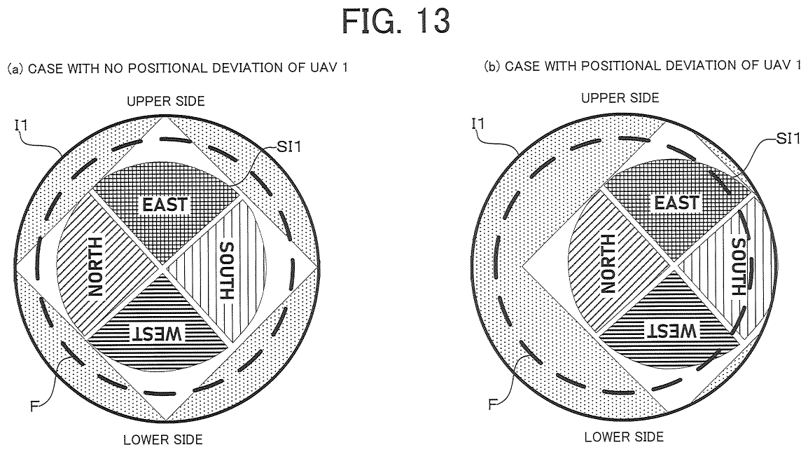

FIG. 13 is a diagram illustrating (a) case with no positional deviation of the UAV 1 and (b) case with positional deviation of the UAV 1 in the image I1 indicated by the image information. In this case, a determination frame F is set in the image I1. Then, in a case where it is recognized that the sign SI1 is within the determination frame F as illustrated in (a) of FIG. 13 by the image analysis of the image I1, the UAV position appropriateness determination unit 340 determines that the position of the UAV 1 is appropriate (That is, there is no positional deviation.). On the other hand, in a case where it is recognized that the sign SI1 is not within the determination frame F as illustrated in (b) of FIG. 13 by the image analysis of the image I1, the UAV position appropriateness determination unit 340 determines that the position of the UAV 1 is not appropriate (That is, there is positional deviation.).

When the difference between the direction indicated by the airframe orientation detected by the airframe orientation detection unit 332 and the direction indicated by the direction information acquired by the direction information acquisition unit 336 is less than the threshold value sh11 (45 degrees, for example) but is equal to or greater than the threshold value sh12 (10 degrees, for example), the worker notification unit 341 makes a notification for prompting the worker W at the port P where the UAV 1 is placed to check the airframe orientation of the UAV 1. This allows the worker W to rearrange the UAV 1 in an appropriate airframe orientation, in order to confirm whether the difference between both directions is caused by influence of disturbance of geomagnetism. Moreover, when the flyability determining unit 338 determines that the airframe orientation of the DAV 1 is not appropriate, the worker notification unit 341 notifies the worker W at the port P where the UAV 1 is placed to prompt the worker W to check the airframe orientation of the UAV 1. This leads the worker W into rearranging the UAV 1 in an appropriate airframe orientation.

Moreover, when the port appropriateness determination unit 339 determines that the port P in which the UAV 1 is placed is not appropriate, the worker notification unit 341 performs notification for prompting the worker W at the port P in which the UAV 1 is placed to check the port P. This allows the worker W to rearrange the UAV 1 from the current port P to the appropriate port P. Moreover, when the UAV position appropriateness determination unit 340 determines that the position of the UAV 1 is not appropriate (That is, there is positional deviation.), the worker notification unit 341 notifies the worker W at the port P in which the UAV 1 is placed to prompt the worker W to check the position of the UAV 1. This allows the worker W to rearrange the UAV 1 at an appropriate position on the port P.

[2. Operation of UAV inspection system S]

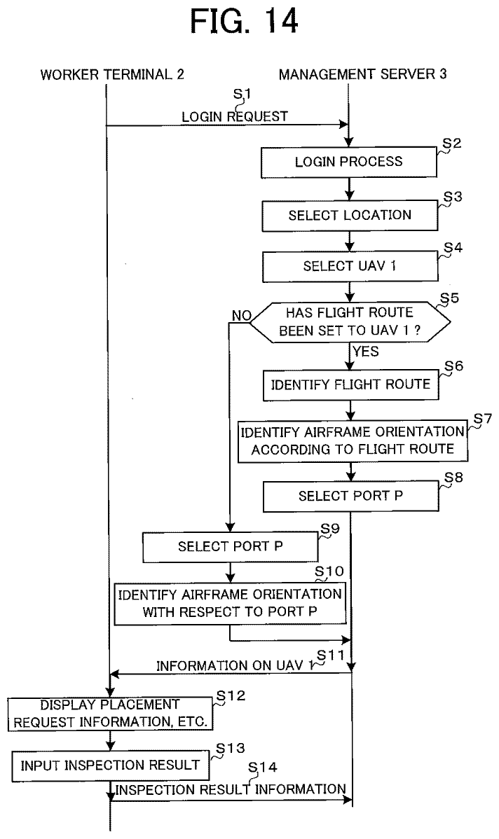

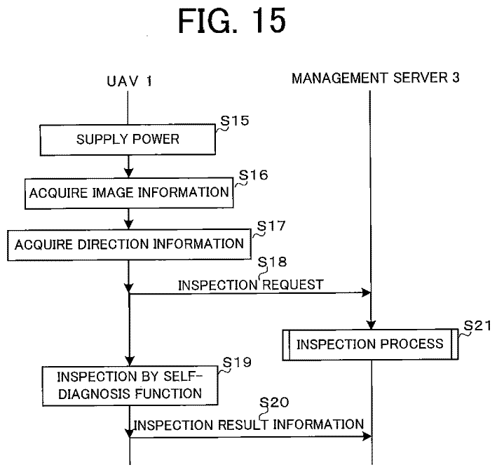

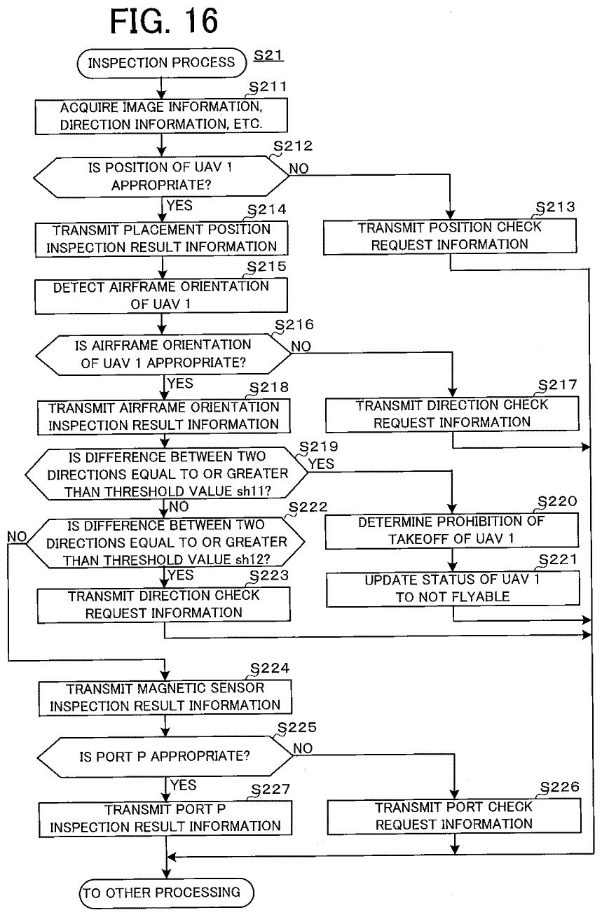

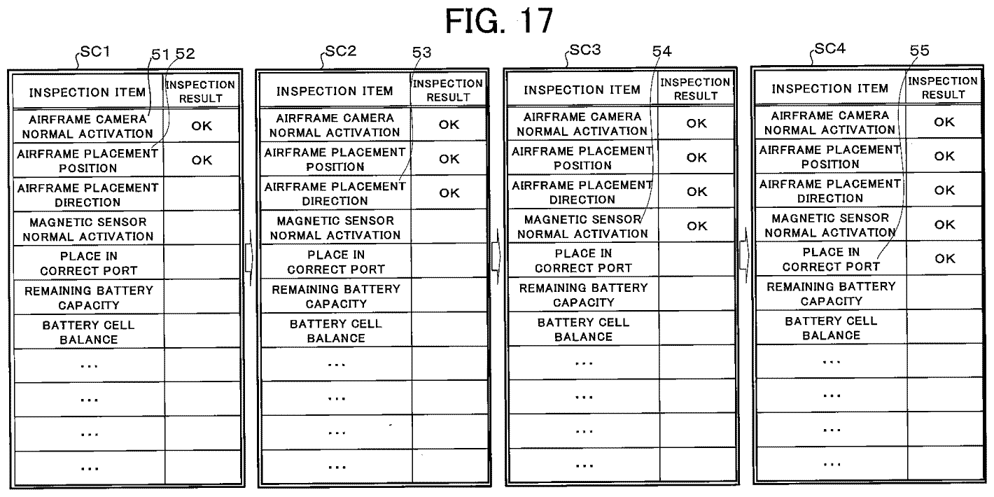

Next, with reference to FIGS. 14 to 17, the operation of the UAV inspection system S when the pre-flight inspection of the UAV 1 is performed at the port P will be described. FIG. 14 is a sequence diagram illustrating an example of processing executed by the worker terminal 2 and the management server 3. FIG. 15 is a sequence diagram illustrating an example of processing executed by the UAV 1 and the management server 3. FIG. 16 is a flowchart illustrating details of the inspection process in step S21 illustrated in FIG. 15. FIG. 17 is a diagram illustrating a display example of an inspection result check screen on the worker terminal 2. Incidentally, in the following operation example, description of processing (processing of the management server 3) for the inspection result information transmitted from the UAV 1 and the worker terminal 2 to the management server 3 will be omitted.

First, in the worker terminal 2, when the worker application is activated in response to an instruction from the worker W, a login screen is displayed. Then, the worker terminal 2 transmits a login request including a user ID and a password input by the worker W through the login screen to the management server 3 (step S1). Thereafter, the screen displayed on the worker terminal 2 is appropriately switched.

Next, upon receiving a login request from the worker terminal 2, the management server 3 performs a login process in response to the login request (step S2). In such a login process, it is determined whether or not a set of the user ID and the password included in the login request is registered. For example, when the set of the user ID and the password included in the login request has been stored in the worker management database 321, it is determined that the set of the user ID and the password has been registered, and the worker W using the worker terminal 2 logs in.

Next, the management server 3 selects a base to which the worker W belongs (step S3). For example, the base is selected by identifying the base ID associated with the user ID of the worker W in the worker management database 321. Next, the management server 3 selects (for example, select by airframe ID) one UAV 1 whose status is waiting to be replaced among the UAVs 1 under the control of the base selected in step S3 (step S4).

Next, the management server 3 determines whether a flight route is set for the UAV 1 selected in step S4 by referring to the UAV management database 323 (step S5). In a case where it is determined that the flight route has been set for the selected UAV 1 (step S5: YES), the processing proceeds to step S6. On the other hand, when it is determined that the flight route is not set for the selected UAV 1 (step S5: NO), the process proceeds to step S9.

In step S6, the management server 3 identifies the flight route of the selected UAV 1. Next, the management server 3 identifies the airframe orientation according to the flight route identified in step S6 (the airframe orientation to be the expected value of the management server 3) by the airframe orientation identification unit 334 (step S7). For example, as described above, the airframe orientation identification unit 334 refers to the first association information to identify the airframe orientation associated with the flight route. Next, the management server 3 selects one port P (selects by port ID, for example) provided in the base selected in step S3 (step S8), and advances the processing to step S11. For example, in a case where the most suitable airframe orientation differs depending on the position of each of the plurality of ports P provided in the base, one port P corresponding to the airframe orientation identified in step S7 is selected.

On the other hand, in step S9, the management server 3 selects one port P provided in the base selected in step S3. For example, one port P whose usage status is not in use is selected from among the plurality of ports P provided in the base. Next, the management server 3 identifies the airframe orientation with respect to the port P selected in step S9 (the airframe orientation corresponding to the expected value of the management server 3) by the airframe orientation identification unit 334 (step S10), and the processing proceeds to step S11. For example, as described above, the airframe orientation identification unit 334 refers to the second association information to identify the airframe orientation associated with the port color of the port P selected in step S9. Incidentally, in step S10, the airframe orientation registered in advance may be identified.

In step S11, the management server 3 transmits the information regarding the UAV 1 selected in step S4 to the worker terminal 2 of the worker W who has logged in. The information related to the UAV 1 includes placement request information prompting placement of the UAV 1 selected in step S4 in the port P (that is, the port P selected in step S8 or S9) in the airframe orientation identified in step S7 or S10. For example, the placement request information includes the airframe orientation (facing north, for example) of the UAV 1 and the port color (light blue, for example) of the port P.

Next, upon receiving the information regarding the UAV 1 from the management server 3, the worker terminal 2 displays the placement request information together with the name and status of the UAV 1 on, for example, the UAV information display screen (step S12). On the UAV information display screen, for example, a message such as “Place Airframe ABC in the light blue port with the front of the airframe facing north.” is displayed. In response to this, the worker W places the UAV 1 in the port P with the airframe orientation facing north, and turns on the power switch of the UAV 1. Then, the worker W inspects the UAV 1. The worker terminal 2 inputs the inspection result from the worker W through the inspection result input screen (step S13), and transmits inspection result information indicating the input inspection result to the management server 3 together with the airframe ID of the UAV 1 (step S14).

In FIG. 15, when the UAV 1 is powered on (step S15), the UAV 1 acquires image information indicating an image including at least a part of a sign captured by the camera (step S16). Next, the UAV 1 acquires direction information indicating the direction detected by the magnetic sensor (step S17). Next, the UAV 1 transmits an inspection request including the image information acquired in step S15, the direction information acquired in step S17, and the airframe ID of the UAV 1 to the management server 3 (step S18). Such an inspection request may include position information of the UAV 1. Incidentally, the processing of steps S16 to S18 may be repeatedly executed at predetermined time intervals until the inspection is completed. Moreover, the inspection request may be transmitted to the management server 3 via the GCS. Then, the UAV 1 performs inspection by the self-diagnosis function (step S19), and transmits inspection result information indicating the inspection result to the management server 3 together with the airframe ID of the UAV 1 (step S20).

Next, upon receiving the inspection request from the UAV 1, the management server 3 performs an inspection process (step S21). In such an inspection process, as illustrated in FIG. 16, the management server 3 acquires the image information, the direction information, and the airframe ID from the inspection request (step S211). Next, the management server 3 causes the UAV position appropriateness determination unit 340 to determine whether or not the position of the UAV 1 placed in port P is appropriate as described above on the basis of at least one of the position of the sign in the image indicated by the image information acquired in step S211 and the indication of the sign (step S212).

Then, when it is determined that the position of the UAV 1 is not appropriate (That is, there is positional deviation of the UAV 1.) (step S212: NO), the management server 3 transmits position check request information prompting a check of the position of the UAV 1 to the worker terminal 2 of the worker W who has logged in (step S213), and the process proceeds to other processing. Upon receiving the position check request information from the management server 3, the worker terminal 2 displays the position check request information on, for example, a check request screen. In this manner a notification for prompting the worker W to check the position of the UAV 1 is made. With this configuration, the worker W attempts to rearrange the UAV 1 at an appropriate position on the port P. Then, after a predetermined time from the notification, the management server 3 starts the processing again from step S211.

On the other hand, when it is determined that the position of the UAV 1 is appropriate (step S212: YES), the management server 3 transmits the inspection result information of the placement position of the UAV 1 to the worker terminal 2 of the worker W who has logged in (step S214), and the process proceeds to step S215. Upon receiving the inspection result information from the management server 3, the worker terminal 2 displays that the placement position of the UAV 1 is appropriate, for example, on the inspection result check screen. Incidentally, the inspection result information may indicate that the camera of the UAV 1 is normally activated. For example, in the inspection result check screen SC1 illustrated in FIG. 17, a mark “OK” (indicating that the inspection result is good) is displayed on the right side of the inspection item “AIRFRAME CAMERA NORMAL ACTIVATION” 51, and a mark “OK” is displayed on the right side of the inspection item “AIRFRAME PLACEMENT POSITION” 52.

In step S215, the management server 3 detects the airframe orientation of the UAV 1 by the airframe orientation detection unit 332 as described above on the basis of at least one of the position of the sign and the indication of the sign in the image indicated by the image information acquired in step S211. Next, the management server 3 compares the airframe orientation detected in step S215 with the airframe orientation (that is, the airframe orientation to be the expected value of the management server 3) identified in step S7 or S10, and as described above, the airframe orientation appropriateness determination unit 335 determines whether or not the airframe orientation of the UAV 1 placed in the port P is appropriate (step S216).

Then, when it is determined that the airframe orientation of the UAV 1 is not appropriate (step S216: NO), the management server 3 transmits direction check request information prompting the check of the airframe orientation of the UAV 1 to the worker terminal 2 of the worker W who has logged in (step S217), and the process proceeds to other processing. Upon receiving the direction check request information from the management server 3, the worker terminal 2 displays the direction check request information on, for example, the check request screen. In this manner, the worker W is notified to prompt the check of the airframe orientation of the UAV 1. With this configuration, the worker W tries to rearrange the UAV 1 at an appropriate airframe orientation. Then, after a predetermined time from the notification, the management server 3 starts the processing again from step S211.

On the other hand, when it is determined that the airframe orientation of the UAV 1 is appropriate (step S216: YES), the management server 3 transmits the inspection result information of the airframe orientation to the worker terminal 2 of the worker W who has logged in (step S218), and the process proceeds to step S219. Upon receiving the inspection result information from the management server 3, the worker terminal 2 displays that the airframe orientation of the UAV 1 is appropriate, for example, on the inspection result check screen. For example, in the inspection result check screen SC2 illustrated in FIG. 17, a mark “OK” (indicating that the inspection result is good) is displayed on the right side of the inspection item “AIRFRAME PLACEMENT DIRECTION” 53.

In step S219, the management server 3 determines, by the sensor abnormality determination unit 337, whether or not the difference between the direction indicated by the airframe orientation detected in step S215 and the direction indicated by the direction information acquired in step S211 is equal to or greater than the threshold value sh11. When it is determined that the difference between both directions is equal to or larger than the threshold sh11 (That is, it is determined that the magnetic sensor of the UAV 1 is abnormal.) (step S219: YES), the management server 3 determines to prohibit the takeoff of the UAV 1 (step S220), updates the status of the UAV 1 to be not flyable (step S221), and the process proceeds to other processing. On the other hand, when it is determined in step S219 that the difference between both directions is not equal to or greater than the threshold sh11 (step S219: NO), the process proceeds to step S222.

In step S222, the management server 3 determines whether or not the difference between the two directions is equal to or greater than the threshold value sh12 (<sh11). When it is determined that the difference between the two directions is equal to or greater than the threshold sh12 (step S222: YES), the management server 3 transmits direction check request information prompting the check of the airframe orientation of the UAV 1 to the worker terminal 2 of the worker W who has logged in (step S223), and the process proceeds to other processing. Upon receiving the direction check request information from the management server 3, the worker terminal 2 displays the direction check request information on, for example, the check request screen. In this manner, the worker W is notified to prompt the check of the airframe orientation of the UAV 1. As a result, the worker W tries to rearrange the UAV 1 in an appropriate airframe orientation in order to confirm whether the difference between both directions is caused by the influence of the disturbance of geomagnetism. Then, after a predetermined time from the notification, the management server 3 starts the processing again from step S211.

On the other hand, when it is determined in step S222 that the difference between both directions is not equal to or greater than the threshold sh12 (step S222: NO), the management server 3 transmits the inspection result information of the magnetic sensor to the worker terminal 2 of the worker W who has logged in (step S224), and the process proceeds to step S225. Upon receiving the inspection result information from the management server 3, the worker terminal 2 displays that the magnetic sensor of the UAV 1 is normal on, for example, the inspection result check screen. For example, in the inspection result check screen SC3 illustrated in FIG. 17, a mark “OK” is displayed on the right side of the inspection item “MAGNETIC SENSOR NORMAL ACTIVATION” 54.

In step S225, the management server 3 determines whether or not the port P in which the UAV 1 is placed is appropriate by the port appropriateness determination unit 339 as described above on the basis of the port color identified from the image indicated by the image information acquired in step S211 and the port color associated with the port ID of the port P selected in step S8 or S9. Incidentally, in step S225, the management server 3 may identify the port P where the UAV 1 is placed on the basis of the position information of the UAV 1. In this case, the port P located closest to the current position indicated by the position information of the UAV 1 is identified from the port management database 322. Then, it is determined whether or not the port P is appropriate on the basis of the port color identified from the image indicated by the image information and the port color associated with the port ID of the port P identified on the basis of the position information of the UAV 1.

Then, when it is determined that the port P is not appropriate (step S225: NO), the management server 3 transmits port check request information prompting check of the port P to the worker terminal 2 of the worker W who has logged in (step S226), and the process proceeds to other processing. Upon receiving the port check request information from the management server 3, the worker terminal 2 displays the port check request information on, for example, a check request screen. In this manner, a notification to prompt the worker W to check the port P is made. As a result, the worker W tries to rearrange (change) the UAV 1 from the current port P to the appropriate port P. Then, after a predetermined time from the notification, the management server 3 starts the processing again from step S211.

On the other hand, when it is determined that the port P is appropriate (step S225: YES), the management server 3 transmits the inspection result information of the port P to the worker terminal 2 of the worker W who has logged in (step S227), and the process proceeds to other processing. Upon receiving the inspection result information from the management server 3, the worker terminal 2 displays that the port P is appropriate, for example, on the inspection result check screen. For example, in the inspection result check screen SC4 illustrated in FIG. 17, a mark “OK” is displayed on the right side of the inspection item “PLACE IN CORRECT PORT” 55.

As described above, according to the above embodiment, the management server 3 acquires the image information indicating the image that includes at least a part of the sign attached in advance in the port P where the UAV 1 is placed and is captured by the camera of the UAV 1, and detects the airframe orientation of the UAV 1 on the basis of at least one of the position of the sign and the indication of the sign in the image indicated by the image information. Therefore, for example, even when the geomagnetism is disturbed due to the influence of the magnetic field, the airframe orientation of the UAV 1 can be appropriately detected without depending on the magnetic sensor. Moreover, according to the above embodiment, after the worker visually confirms the airframe orientation, the work (load reduction) of confirming whether or not the confirmed airframe orientation matches the detection value (display value) of the magnetic sensor of the airframe can be reduced. As a result, human error caused by the worker can be eliminated.

Incidentally, the above-described embodiment is one embodiment of the present invention, and the present invention is not limited to the above-described embodiment, changes from the above-described embodiment can be made on various configurations and the like within a scope not departing from the gist of the present invention, and such cases shall be also included in the technical scope of the present invention. In the above embodiment, instead of the management server 3, the UAV 1 may be configured to function as all or a part of the image information acquisition unit 331, the airframe orientation detection unit 332, the flight route identification unit 333, the airframe orientation identification unit 334, the airframe orientation appropriateness determination unit 335, the direction information acquisition unit 336, the sensor abnormality determination unit 337, the flyability determining unit 338, the port appropriateness determination unit 339, the UAV position appropriateness determination unit 340, and the worker notification unit 341 described above. In this case, the UAV 1 appropriately acquires information (for example, installation information of the sign in the port P, and a flight route of the UAV 1) necessary for processing from the management server 3 . . . . Moreover, according to the above embodiment, the UAV has been described as an example of the unmanned aerial vehicle, but the present invention is also applicable to a flying robot or the like as another example of the unmanned aerial vehicle.

### <Note>

An information processing device according to the present disclosure includes: a first acquisition unit configured to acquire image information that indicates an image including at least a part of a sign attached in advance in a port in which an unmanned aerial vehicle is placed, the image being captured by a camera in the unmanned aerial vehicle; and a detection unit configured to detect an airframe orientation of the unmanned aerial vehicle on the basis of at least one of a position of the sign and indication of the sign in the image indicated by the image information. This makes it possible to appropriately detect an airframe orientation of the unmanned aerial vehicle even in a case where geomagnetism is disturbed.

[2] The information processing device described in [1] above, further includes: a second acquisition unit configured to acquire direction information indicating a direction detected by a magnetic sensor in the unmanned aerial vehicle; and a first determination unit configured to determine whether or not the magnetic sensor is abnormal by comparing a direction indicated by the airframe orientation detected by the detection unit and the direction indicated by the direction information. This makes it possible to more accurately detect abnormality of the magnetic sensor.

[3] In the information processing device described in [2] above, the first determination unit determines that the magnetic sensor is abnormal in a case where a difference between the direction indicated by the airframe orientation detected by the detection unit and the direction indicated by the direction information is equal to or greater than a first threshold value. This makes it possible to more efficiently detect abnormality of the magnetic sensor.

The information processing device described in [2] or [3] above, further includes a determining unit configured to determine prohibition of takeoff of the unmanned aerial vehicle in a case where the first determination unit determines that the magnetic sensor is abnormal. This makes it possible to efficiently prevent flight of the unmanned aerial vehicle in which the magnetic sensor is abnormal.

[5] The information processing device described in any one of [2] to [4] above, further includes a notification unit configured to notify a staff member at the port to check the airframe orientation in a case where the difference between the direction indicated by the airframe orientation detected by the detection unit and the direction indicated by the direction information is less than the first threshold value and equal to or greater than a second threshold value. This allows the staff member to rearrange the unmanned aerial vehicle in an appropriate airframe orientation, in order to confirm whether the difference between both directions is caused by influence of disturbance of geomagnetism.

[6] The information processing device described in any one of [1] to [5] above, further includes: a first identification unit configured to identify a planned flight route of the unmanned aerial vehicle; a second identification unit configured to identify an airframe orientation according to the planned flight route; and a second determination unit configured to determine whether or not the airframe orientation of the unmanned aerial vehicle is appropriate by comparing the airframe orientation detected by the detection unit and the airframe orientation identified by the second identification unit. This makes it possible to accurately detect that the unmanned aerial vehicle is placed in an inappropriate airframe orientation.

[7] The information processing device described in any one of [1] to [5] above, further includes: a third identification unit configured to identify an airframe orientation with respect to the port in which the unmanned aerial vehicle is placed; and a second determination unit configured to determine whether or not the airframe orientation of the unmanned aerial vehicle is appropriate by comparing the airframe orientation detected by the detection unit and the airframe orientation identified by the third identification unit. This makes it possible to accurately detect that the unmanned aerial vehicle is placed in an inappropriate airframe orientation.

[8] The information processing device described in [6] or [7] above, further includes a notification unit configured to notify a staff member at the port to check the airframe orientation of the unmanned aerial vehicle in a case where the second determination unit determines that the airframe orientation is not appropriate. This allows the staff member to rearrange the unmanned aerial vehicle in an appropriate airframe orientation.

[9] The information processing device described in any one of [1] to [8] above, further includes: a third determination unit configured to determine whether or not the port in which the unmanned aerial vehicle is placed is appropriate on the basis of the indication of the sign in the image indicated by the image information and installation information of the sign in the port. This makes it possible to accurately detect that the unmanned aerial vehicle is arranged in an inappropriate port.

[10] The information processing device described in [9] above, further includes a notification unit configured to notify a staff member at the port to check the port in a case where the third determination unit determines that the port is not appropriate. This allows the staff member to rearrange the unmanned aerial vehicle from the current port to an appropriate port.

[11] The information processing device described in any one of [1] to [10] above, further includes a fourth determination unit configured to determine whether or not the position of the placed unmanned aerial vehicle is appropriate on the basis of at least one of the position of the sign and the indication of the sign in the image indicated by the image information. This makes it possible to accurately detect that the unmanned aerial vehicle is arranged at an inappropriate position.

[12] The information processing device described in [11] above, further includes a notification unit configured to notify the staff member at the port to check the position in a case where that the fourth determination unit determines that the position is not appropriate. This allows the staff member to rearrange the unmanned aerial vehicle at an appropriate position on the port.

[13] In the information processing device described in any one of [1] to [12] above, the detection unit detects the airframe orientation of the unmanned aerial vehicle on the basis of the position of the sign and the indication of the sign in the image indicated by the image information. This makes it possible to more accurately detect an airframe orientation of the unmanned aerial vehicle.

[14] In the information processing device described in any one of [1] to [13] above, the detection unit detects the airframe orientation of the unmanned aerial vehicle on the basis of at least one of the position of the sign and the indication of the sign in the image indicated by the image information, and installation information of the sign in the port. This makes it possible to more accurately detect an airframe orientation of the unmanned aerial vehicle.

[15] An unmanned aerial vehicle according to the present disclosure includes: a camera; a first acquisition unit configured to acquire image information that indicates an image including at least a part of a sign attached in advance in a port in which an unmanned aerial vehicle is placed, the image being captured by the camera; and a detection unit configured to detect an airframe orientation of the unmanned aerial vehicle on the basis of at least one of a position of the sign and indication of the sign in the image indicated by the image information.

[16] A method executed by a computer for detecting airframe orientation, according to the present disclosure includes: a step of acquiring, by the computer, image information that indicates an image including at least a part of a sign attached in advance in a port in which an unmanned aerial vehicle is placed, the image being captured by a camera in the unmanned aerial vehicle; and a step of detecting, by the computer, an airframe orientation of the unmanned aerial vehicle on the basis of at least one of a position of the sign and indication of the sign in the image indicated by the image information.

### REFERENCE SIGNS LIST

1 UAV
2 Worker terminal
3 Management server
11 Power supply unit
12 Drive unit
13 Positioning unit
14 Communication unit
15 Sensor unit
16 Storage unit
17 Control unit
21 Operation/display unit
22 Communication unit
23 Storage unit
24 Control unit
31 Communication unit
32 Storage unit
33 Control unit
331 Image information acquisition unit
332 Airframe orientation detection unit
333 Flight route identification unit
334 Airframe orientation identification unit
335 Airframe orientation appropriateness determination
unit
336 Direction information acquisition unit
337 Sensor abnormality determination unit
338 Flyability determining unit
339 Port appropriateness determination unit
340 UAV position appropriateness determination unit
341 Worker notification unit
NW Communication network
S UAV inspection system

1. An information processing device comprising:
at least one memory configured to store program code; and at least one processor configured to access the program code and operate as instructed by the program code, the program code including:
first acquisition code configured to cause the at least one processor to acquire image information that indicates an image including at least a part of a sign attached in advance in a port in which an unmanned aerial vehicle is placed, the image being captured by a camera in the unmanned aerial vehicle; and
detection code configured to cause the at least one processor to detect a first airframe orientation of the unmanned aerial vehicle on the basis of at least one of a position of the sign and indication of the sign in the image indicated by the image information.

2. The information processing device according to claim 1, the program code further including:
second acquisition code configured to cause the at least one processor to acquire direction information indicating a first direction detected by a magnetic sensor in the unmanned aerial vehicle; and
first determination code configured to cause the at least one processor to determine whether or not the magnetic sensor is abnormal by comparing a second direction indicated by the first airframe orientation and the first direction indicated by the direction information.

3. The information processing device according to claim 2, wherein the first determination code causes the at least one processor to determines that the magnetic sensor is abnormal in a case where a difference between the second direction indicated by the first airframe orientation and the first direction indicated by the direction information is equal to or greater than a first threshold value.

4. The information processing device according to claim 3, the program code further including determining code configured to cause the at least one processor to determine prohibition of takeoff of the unmanned aerial vehicle in a case where it is determined that the magnetic sensor is abnormal.

5. The information processing device according to claim 2, the program code further including a notification code configured to cause the at least one processor to notify a staff member at the port to check the first airframe orientation in a case where the difference between the second direction indicated by the first airframe orientation and the first direction indicated by the direction information is less than the first threshold value and equal to or greater than a second threshold value.

6. The information processing device according to claim 1, the program code further including:
first identification code configured to cause the at least one processor to identify a planned flight route of the unmanned aerial vehicle;
second identification code configured to cause the at least one processor to identify a second airframe orientation according to the planned flight route; and
second determination code configured to cause the at least one processor to determine whether or not the first airframe orientation of the unmanned aerial vehicle satisfies a prescribed condition by comparing the first airframe orientation and the second airframe orientation.

7. The information processing device according to claim 1, the program code further including:
third identification code configured to cause the at least one processor to identify a third airframe orientation with respect to the port in which the unmanned aerial vehicle is placed; and
second determination code configured to cause the at least one processor to determine whether or not the first airframe orientation of the unmanned aerial vehicle satisfies a prescribed condition by comparing the first airframe orientation and the third airframe orientation.

8. The information processing device according to claim 6, the program code further including notification code configured to cause the at least one processor to notify a staff member at the port to check the first airframe orientation of the unmanned aerial vehicle in a case where it is determined that the first airframe orientation does not satisfy the prescribed condition.

9. The information processing device according to claim 1, the program code further including third determination code configured to cause the at least one processor to determine whether or not the port in which the unmanned aerial vehicle is placed satisfies a prescribed condition on the basis of the indication of the sign in the image indicated by the image information and installation information of the sign in the port.

10. The information processing device according to claim 9, the program code further including notification code configured to cause the at least one processor to notify a staff member at the port to check the port in a case where it is determined that the port does not satisfy the prescribed condition.

11. The information processing device according to claim 1, the program code further including fourth determination code configured to cause the at least one processor to determine whether or not the position of the placed unmanned aerial vehicle satisfies a prescribed condition on the basis of at least one of the position of the sign and the indication of the sign in the image indicated by the image information.

12. The information processing device according to claim 11, the program code further including notification code configured to cause the at least one processor to notify the staff member at the port to check the position in a case where that it is determined that the position does not satisfy the prescribed condition.

13. The information processing device according to claim 1, wherein the detection code causes the at least one processor to detect the first airframe orientation of the unmanned aerial vehicle on the basis of the position of the sign and the indication of the sign in the image indicated by the image information.

14. The information processing device according to claim 1, wherein the detection code causes the at least one processor to detects the first airframe orientation of the unmanned aerial vehicle on the basis of at least one of the position of the sign and the indication of the sign in the image indicated by the image information, and installation information of the sign in the port.

15. An unmanned aerial vehicle comprising:
a camera;
at least one memory configured to store program code; and at least one processor configured to access the program code and operate as instructed by the program code, the program code including:
first acquisition code configured to cause the at least one processor to acquire image information that indicates an image including at least a part of a sign attached in advance in a port in which an unmanned aerial vehicle is placed, the image being captured by the camera; and
detection code configured to cause the at least one processor to detect a first airframe orientation of the unmanned aerial vehicle on the basis of at least one of a position of the sign and indication of the sign in the image indicated by the image information.

16. A method executed by a computer for detecting airframe orientation comprising:
acquiring, by the computer, image information that indicates an image including at least a part of a sign attached in advance in a port in which an unmanned aerial vehicle is placed, the image being captured by a camera in the unmanned aerial vehicle; and
detecting, by the computer, a first airframe orientation of the unmanned aerial vehicle on the basis of at least one of a position of the sign and indication of the sign in the image indicated by the image information.
